(19) United States
(12) Patent Application Publication
(10) Pub. No.: US 2024/0424505 A1
(43) Pub. Date: Dec. 26, 2024

(54) ABLUTIONARY OR PLUMBING APPARATUS

(71) Applicant: KOHLER MIRA LIMITED, Cheltenham (GB)

(72) Inventors: Barry Hobbs, Cheltenham (GB); Richard Harcourt BURNS, Cheltenham (GB)

(21) Appl. No.: 18/736,003

(22) Filed: Jun. 6, 2024

(30) Foreign Application Priority Data
Jun. 22, 2023 (GB) 2309434.5

(51) Int. Cl. B05B 1/16; B05B 1/18

(52) U.S. Cl. CPC B05B 1/1663; B05B 1/18

(57) ABSTRACT

An apparatus includes a valve assembly, which includes a valve inlet, two or more valve outlets, and a switching element to allow fluid communication between the inlet and a first valve outlet and/or the second valve outlet. Fluidic pressure acting on the switching element above or below a threshold value causes fluid communication between the inlet and the first valve outlet but not the second, or between the inlet and the second valve outlet but not the first. A first set of fluid delivery outlets are in fluid communication with the first valve outlet, and provide a first spray mode. A second set of fluid delivery outlets in fluid communication with the second valve outlet, and provide a second spray mode.

### CROSS-REFERENCE TO RELATED APPLICATIONS

This application claims priority to UK Patent Application No. 2309434.5, filed 22 Jun. 2023, the entirety of which is hereby incorporated by reference.

### FIELD OF THE INVENTION

This disclosure relates to an ablutionary or plumbing apparatus. More specifically, this disclosure relates to an ablutionary apparatus including a spray head for use in a plumbing fixture or ablutionary installation such as a shower or faucet.

### BACKGROUND OF THE INVENTION

It is known to employ various types of spray heads in ablutionary systems. Often such spray heads are adapted to provide multiple spray modes. Conventionally, switching spray modes requires the user to actuate a valve mechanism manually (e.g., using a lever or a button). A detriment of this approach is that the user needs to interact directly with the spray head.

As an alternate, some spray heads utilise electronic controllers including solenoid activated or motor diverters to enable switching between spray modes. This approach again requires the user to interact directly with the spray head or to utilise a remote electronic interface which requires wiring to the controller or energy storage for wireless connections (e.g., Bluetooth). Wired or wireless connections increase the complexity and cost of installation and maintenance of such spray heads.

### BRIEF DESCRIPTION OF THE DRAWINGS

There now follows by way of example only a detailed description with reference to the accompanying drawings, in which:

FIG. 1 illustrates a cross-section of an example valve assembly.

FIG. 2 illustrates a cross-section of an example ablutionary apparatus in a first spray mode.

FIG. 3 illustrates a cross-section of an example ablutionary apparatus in a second spray mode.

FIG. 4 illustrates a cross-section of an example ablutionary apparatus in a third spray mode.

FIG. 5 illustrates an example valve assembly.

FIG. 6 illustrates a cross-sectional view of an example valve assembly.

FIG. 7 illustrates a cross-section of an example ablutionary apparatus in a first spray mode.

FIG. 8 illustrates a cross-section of an example ablutionary apparatus in a second spray mode.

FIG. 9 illustrates a cross-section of an example ablutionary apparatus in a third spray mode.

FIG. 10 shows an example system for installation in an ablutionary environment.

### DETAILED DESCRIPTION OF THE DRAWINGS

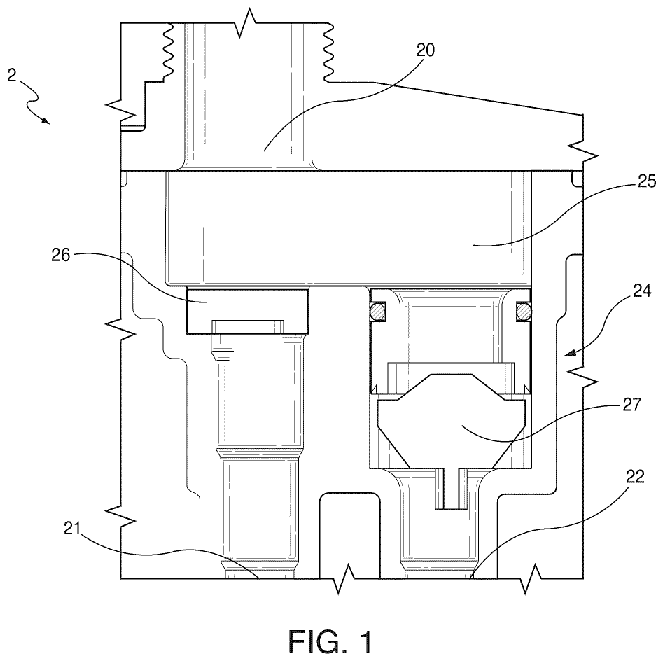

FIG. 1 shows a valve assembly 2 for use in an ablutionary or plumbing apparatus. The valve assembly 2 comprises a valve inlet 20 through which fluid is supplied, in use, to an antechamber 25. As will be described in more detail below, fluid can then flow, in use, from the antechamber 25 to a first valve outlet 21 and a second valve outlet 22.

The valve assembly 2 further comprises a switching element 24 operable to selectively allow fluid communication between the valve inlet 20 and the second valve outlet 22. The switching element 24 may be actuated by a fluidic pressure within the antechamber 25. In this example, the switching element 24 comprises a pressure relief valve 27. When the fluidic pressure acting on the switching element 24 is below a threshold fluidic pressure, the pressure relief valve 27 is closed and the switching element 24 is said to be operating in a first mode. In the first mode, the pressure relief valve 27 prevents fluid communication between the antechamber 25 and the second valve outlet 22. In the first mode, the antechamber 25, and by extension the valve inlet 20, is fluidically connected to the first valve outlet 21 and is not fluidically connected to the second valve outlet 22.

In contrast, when the fluidic pressure acting on the switching element 24 meets or exceeds the threshold fluidic pressure, the pressure relief valve 27 is open and the switching element 24 is said to be operating in a second mode. In the second mode, the antechamber 25, and by extension the valve inlet 20, is fluidically connected to both the first valve outlet 21 and the second valve outlet 22.

In this way, the switching element 24 is actuated by fluidic pressure and configured to switch from operating in the first mode to operating in the second mode and vice versa, as a result of a change in fluidic pressure through the threshold fluidic pressure. Such pressure-induced switching may provide a compact alternative to costly and complex digitally controlled switching methods.

Switching between the first and second valve outlets 21, 22 may be actuated by both increasing and decreasing fluidic pressure (through the threshold fluid pressure). This may provide an advantage over conventional diverter valve assemblies, which may maintain a selected outlet using fluid pressure but may not be operable to switch outlets should the pressure increase. Such conventional valve assemblies typically require direct manual or digital actuation of the valve itself. In contrast, the reversible pressure-induced spray mode switching described in this disclosure may provide a compact alternative to conventional switching methods, which often require direct user actuation of the valve(s).

The valve assembly 2 further includes a flow regulator 26 located downstream of an outlet from the antechamber 25 and upstream of the first valve outlet 21. The flow regulator 26 is configured to limit a maximum flow rate output from the first valve outlet 21. The flow regulator may comprise a flow regulating geometry within the valve assembly 2, e.g. a restricting plate with one or more orifices therethrough. When a flow rate from the valve inlet 20 exceeds a flow rate limit of the flow regulator 26, fluidic pressure within the antechamber 25 increases. If the increase in fluidic pressure within the antechamber 25 is sufficient for the fluidic pressure to meet or exceed the threshold fluid pressure, then the pressure relief valve 27 opens, thereby switching the switching element 24 from the first mode to the second mode. In this way, the flow regulator 26 may act to reduce the flow rate from the inlet 20 at which the switching element 24 starts operating in the second mode.

The pressure relief valve 27 may be selected to have an opening pressure substantially equal to or greater than the fluidic pressure within the antechamber 25 when the flow regulator is operating at its flow rate limit. Equally, the flow regulator may be selected to have a maximum flow rate limit such that when the flow regulator is operating at its flow rate limit, the fluidic pressure within the antechamber 25 is substantially equal to or greater than the opening pressure of the pressure relief valve 27. By selecting the pressure relief valve 27 to have an opening pressure greater than the fluidic pressure within the antechamber 25 when the flow regulator is operating at its flow rate limit, a buffer may be provided between switching from the first mode to the second mode and vice versa. Consequently, dripping out of the second mode while the first mode is operating towards its top limit of flow may be prevented or at least reduced. There may be a cleaner cut off when switching from the first mode to the second mode and vice versa.

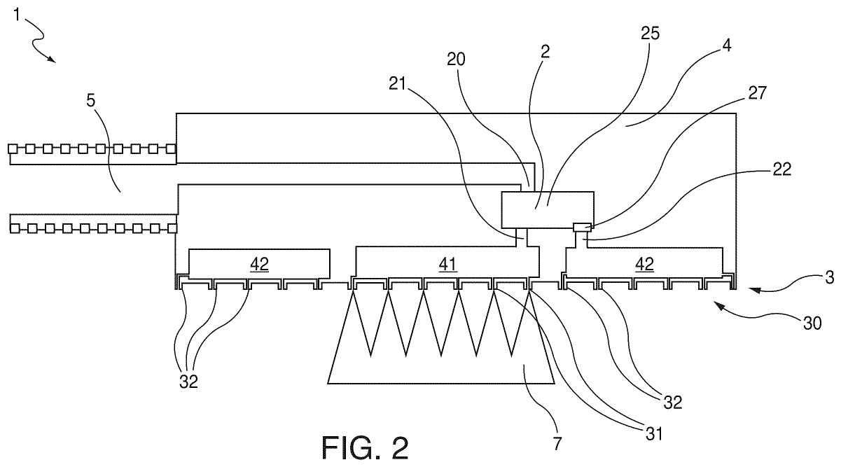

FIG. 2 shows an ablutionary apparatus 1. the ablutionary apparatus 1 comprises a spray head 4 for a shower and includes the valve assembly 2 of FIG. 1. As shown in FIG. 2, the spray head 4 comprises an apparatus inlet 5 which is threaded to enable coupling to a fluid supply pipe (not shown). The valve inlet 20 of the valve assembly 2 is in fluid communication with the apparatus inlet 5.

The spray head 4 comprises a spray face 3 which includes a plurality of fluid delivery outlets 30 comprising a first set of fluid delivery outlets 31 and a second set of fluid delivery outlets 32. In this example, the spray head 4 comprises: a first chamber 41 configured to supply fluid to the first set of fluid delivery outlets 31; and a second chamber 42 configured to supply fluid to the second set of fluid delivery outlets 32. In this example, the second chamber 42 is substantially annular in shape and arranged to at least partially surround the first chamber 41. In the illustrated example, the first set of fluid delivery outlets 31 is located in a centre of the spray face 3 while the second set of fluid delivery outlets 42 is disposed around a perimeter of the spray face 3 such that the first set of fluid delivery outlets 31 is encircled by the second set of fluid delivery outlets 32. In other implementations, the first set of fluid delivery outlets and the second set of fluid delivery outlets may be configured differently relative to each other and/or relative to the spray face. The first set of fluid delivery outlets and the second set of fluid delivery outlets may be configured in any way relative to each other and/or relative to the spray face without departing from the scope of the disclosure.

The apparatus 1 is configured such that the first valve outlet 21 of the valve assembly 2 is in fluid communication with the first set of fluid delivery outlets 31 (via the first chamber 41). Similarly, the apparatus 1 is configured such that the second valve outlet 22 is in fluid communication with the second set of fluid delivery outlets 32 (via the second chamber 42).

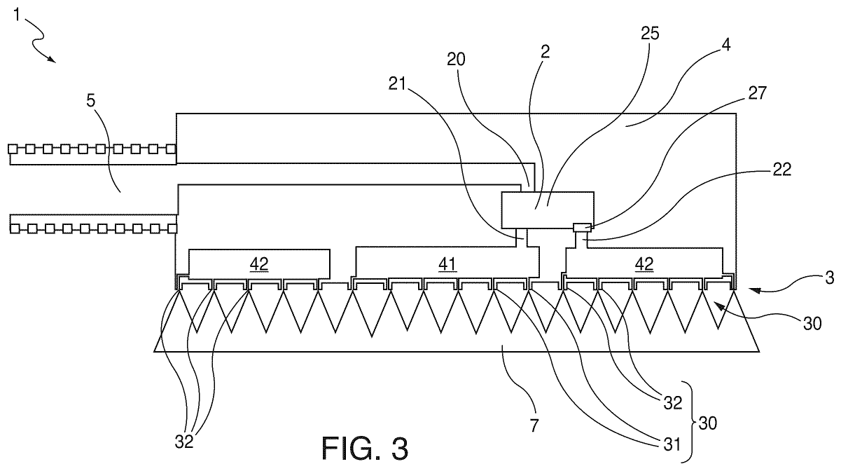

In FIG. 2, the spray head is shown with the switching element 24 (FIG. 1) of the valve assembly 2 operating in the first mode. In the first mode, the antechamber 25, and by extension the valve inlet 20, is fluidically connected to the first valve outlet 21 and is not fluidically connected to the second valve outlet 22. As such, fluid is only supplied to the first set of fluid delivery outlets 31 and the spray head 4 is said to operate in a first spray mode. Fluid output from the plurality of fluid delivery outlets 30 is represented in FIGS. 2 and 3 by grey triangles 7.

FIG. 3 shows the ablutionary apparatus 1 of FIG. 2 when the switching element 24 of the valve assembly 2 is operating in its second mode. In the second mode, the fluidic pressure acting on the switching element 24 (FIG. 1) meets or exceeds the threshold fluidic pressure and the pressure relief valve 27 is open. The antechamber 25, and by extension the valve inlet 20, is fluidically connected to the second valve outlet 22 which feeds the second set of fluid delivery outlets 32 producing a second spray mode. The antechamber 25, and by extension the valve inlet 20, is also fluidically connected to the first valve outlet 21 which feeds the first set of fluid delivery outlets 31 so the spray head 4 operates simultaneously in the first spray mode and a second spray mode. This may beneficially provide greater coverage and a higher net flow rate from the fluid delivery outlets 30, which may have utility in certain washing applications, e.g., hair washing.

In this way, the apparatus 1 is actuated by fluidic pressure and configured to switch from operating in the first spray mode to operating in the first and second spray modes (and vice versa) as a result of a change in fluidic pressure through the threshold fluidic pressure. Such pressure induced spray mode switching may provide a compact alternative to costly and complex digitally controlled switching methods.

In an alternative implementation, the apparatus 1 may be configured such that the first valve outlet 21 of the valve assembly 2 is in fluid communication with the second set of fluid delivery outlets 32 (via the first chamber 42). In this case, the apparatus 1 may be configured such that the second valve outlet 22 is in fluid communication with the first set of fluid delivery outlets 31 (via the first chamber 41). Therefore, in the first spray mode, fluid may be supplied only to the second set of fluid delivery outlets 32 and the spray head 4. In this alternative implementation, when the switching element 24 of the valve assembly 2 is operating in its second mode, the fluidic pressure acting on the switching element 24 (FIG. 1) meets or exceeds the threshold fluidic pressure and the pressure relief valve 27 is open. The antechamber 25, and by extension the valve inlet 20, is fluidically connected to the second valve outlet 22 which feeds the first set of fluid delivery outlets 31 producing a second spray mode. The antechamber 25, and by extension the valve inlet 20, is also fluidically connected to the first valve outlet 21 which feeds the second set of fluid delivery outlets 32 so the spray head 4 operates simultaneously in the first spray mode and a second spray mode. This may beneficially provide greater coverage and a higher net flow rate from the fluid delivery outlets 30, which may have utility in certain washing applications, e.g. hair washing.

The ablutionary apparatus 1 may further comprise a controller (not shown) for varying the flow rate from the fluid supply to the at least one valve inlet 20. Varying the flow rate from the fluid supply may be used to vary the fluidic pressure acting on the switching element 24 (FIG. 1), to switch the switching element 24 between modes. Such a controller may be a digital controller configured to vary the flow rate from the fluid supply such that the switching element: switches from the first mode to the second mode upon user actuation of the digital controller; and switches from the second mode to the first mode after a predetermined time period, such as 30 seconds. Returning to a low flow rate after a predetermined time period may improve water economy by offering high flow spray mode to the user only for a limited period of time specific to the required purpose, e.g. hair rinsing.

Alternately, the controller may comprise a non-digital, manually actuated valve, e.g. provided with a lever or a rotatable dial for actuating the controller.

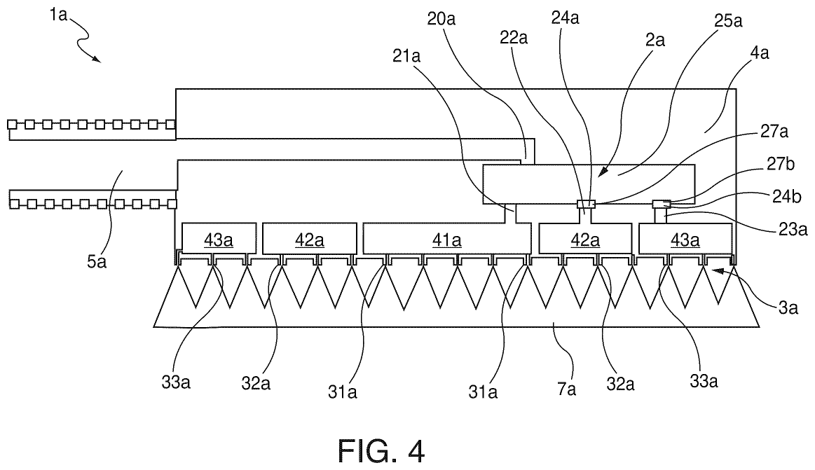

The ablutionary apparatus 1 and valve assembly 2 shown in FIGS. 1-3 should be taken only as examples. For example, it will be apparent to the skilled person that the valve assembly 1 can be scaled to include any number of additional valve outlets each associated with a respective additional operating mode of the switching element (and additional spray mode of the ablutionary apparatus 1). An example of this is shown in FIG. 4.

FIG. 4 shows another example of an ablutionary apparatus 1a. The ablutionary apparatus 1a comprises a spray head 4a for a shower and includes a valve assembly 2a.

As shown in FIG. 4, the spray head 4a comprises an apparatus inlet 5a which is threaded to enable coupling to a fluid supply pipe (not shown). The valve assembly 2a comprises a valve inlet 20a in fluid communication with the apparatus inlet 5.

Fluid is supplied, in use, through the valve inlet 20a to an antechamber 25a. As will be described in more detail below, fluid can then flow, in use, from the antechamber 25 to a first valve outlet 21a, a second valve outlet 22a and a third valve outlet 23a.

The valve assembly 2a comprises: a first switching element 24a operable to allow selectively fluid communication between the valve inlet 20a and the second valve outlet 22a; and a second switching element 24b operable to allow selectively fluid communication between the valve inlet 20a and the third valve outlet 23a.

The first switching element 24a is actuated by fluidic pressure within the antechamber 25a. The first switching element 24a comprises a first pressure relief valve 27a.

The second switching element 24b is actuated by fluidic pressure within the antechamber 25a. The second switching element 24b comprises a second pressure relief valve 27b.

When the fluidic pressure acting on the first switching element 24a is below a first threshold fluidic pressure, the first pressure relief valve 27a is closed and the first switching element 24a is said to be operating in a first mode. In the first mode, the first pressure relief valve 27a prevents fluid communication between the antechamber 25a and the second valve outlet 22a. In the first mode, the antechamber 25a, and by extension the valve inlet 20a, is fluidically connected to the first valve outlet 21a and is not fluidically connected to the second valve outlet 22a.

In contrast, when the fluidic pressure acting on the first switching element 24a meets or exceeds the first threshold fluidic pressure, the first pressure relief valve 27a is open and the first switching element 24a is said to be operating in a second mode. When the first switching element 24a is operating in the second mode, the antechamber 25a, and by extension the valve inlet 20a, is fluidically connected to both the first valve outlet 21a and the second valve outlet 22a.

When the fluidic pressure acting on the second switching element 24b is below a second threshold fluidic pressure, the second pressure relief valve 27b us closed and the second switching element 24b is said to be operating in a first mode. In the first mode, the second pressure relief valve 27b prevents fluids communication between the antechamber 25a and the third valve outlet 23a. In the first mode, the antechamber 25a, and by extension the valve inlet 20a, is fluidically connected to the first valve outlet 21a and is not fluidically connected to the third valve outlet 22b.

In contrast, when the fluidic pressure acting on the second switching element 24b meets or exceeds the second threshold fluidic pressure, the second pressure relief valve 27b is open and the second switching element 24b is said to be operating in a second mode. When the second switching element 24b is operating in the second mode, the antechamber 25a, and by extension the valve inlet 20a, is fluidically connected to both the first valve outlet 21a and the third valve outlet 23a.

In an implementation, the second threshold fluidic pressure may be higher than the first threshold fluidic pressure. When the fluidic pressure within the antechamber 25a acting on the first switching element 24a and the second switching element 24b is below the first threshold fluidic pressure, the first switching element 24a operates in the first mode and the second switching element 24b operates in the first mode. When the fluidic pressure within the antechamber 25a acting on the first switching element 24a and the second switching element 24b meets or exceeds the first fluidic pressure but does not meet or exceed the second fluidic pressure, the first switching element 24a operates in the second mode and the second switching element 24b operates in the first mode. When the fluidic pressure within the antechamber 25a acting on the first switching element 24a and the second switching element 24b meets or exceeds the second fluidic pressure, the first switching element 24a operates in the second mode and the second switching element 24b operates in the second mode.

The valve assembly 2a may include a first flow regulator (not shown) located downstream of a first outlet from the antechamber 25a and upstream of the first valve outlet 21a. The first flow regulator may be configured to limit a maximum flow rate output from the first valve outlet 21a. The first flow regulator may comprise a flow regulating geometry within the valve assembly 2a, e.g. a restricting plate with one or more orifices therethrough.

The valve assembly 2a may include a second flow regulator (not shown) located downstream of a second outlet from the antechamber 25a and upstream of the second valve outlet 22a. The second flow regulator may be configured to limit a maximum flow rate output from the second valve outlet 22a. The second flow regulator may comprise a flow regulating geometry within the valve assembly 2a, e.g. a restricting plate with one or more orifices therethrough.

In implementations, the valve assembly may comprise any number of valve outlets.

In implementations, there may be one fewer flow regulators than valve outlets. For instance, in a valve assembly comprising four valve outlets, i.e. a first valve outlet, a second valve outlet, a third valve outlet and a fourth valve outlet, there may be: a first flow regulator located downstream of a first outlet from an antechamber and upstream of the first valve outlet and configured to limit a maximum flow rate output from the first valve outlet; a second flow regulator located downstream of a second outlet from the antechamber and upstream of the second valve outlet and configured to limit a maximum flow rate output from the second valve outlet; and a third flow regulator located downstream of a third outlet from the antechamber and upstream of the third valve outlet and configured to limit a maximum flow rate output from the third valve outlet.

The or each flow regulator may be configured to limit a maximum flow rate output from a given valve outlet downstream thereof. The or each flow regulator may comprise a flow regulating geometry within the valve assembly, e.g. a restricting plate with one or more orifices therethrough.

The spray head 4a comprises a spray face 3a, which includes a first set of fluid delivery outlets 31a, a second set of fluid delivery outlet 32a and a third set of fluid delivery outlets 33a. The first set of fluid delivery outlets 31a is located in a centre of the spray face 3a. The second set of fluid delivery outlets 32a surrounds the first set of fluid delivery outlets 31a. The third set of fluid delivery outlets 33a surrounds the second set of fluid delivery outlets 32a.

The first set of fluid delivery outlets 31a is in fluid communication with a first chamber 41a behind the spray face 3a. The first chamber 41a is in fluid communication with the first valve outlet 21a.

The second set of fluid delivery outlets 32a is in fluid communication with a second chamber 42a behind the spray face 3a. The second chamber 42a is annular in form and is in fluid communication with the second valve outlet 22a.

The third set of fluid delivery outlets 33a is in fluid communication with a third chamber 43a behind the spray face 3a. In the illustrated example, the third chamber 43a is annular in form and is in fluid communication with the third valve outlet 23a. It will be appreciated that other arrangements of the first chamber 41a, the second chamber 42a and the third chamber 43a relative to each other may be employed without departing from the scope of the disclosure.

In FIG. 4, the spray head 4a is shown with the first switching element 24a operating in the second mode and the second switching element 24b operating in the second mode. Hence, the antechamber 25a, and by extension the valve inlet 20a, is fluidically connected to the first valve outlet 21a, the second valve outlet 22a and the third valve outlet 23a. Fluid is therefore delivered through the first set of fluid delivery outlets 31a, the second set of fluid delivery outlets 32a and the third set of fluid delivery outlets 33a. Fluid output from the fluid delivery outlets is represented in FIG. 4 by grey triangles 7a.

The ablutionary apparatus 1a may further comprise a controller (not shown) for varying the flow rate from the fluid supply to the valve inlet 20a. Varying the flow rate from the fluid supply may be used to vary the fluidic pressure acting on the first switching element 24a and the second switching element 24b, to switch the first switching element 24a and the second switching element 24b between modes. Such a controller may be a digital controller configured to vary the flow rate from the fluid supply such that one or more of the first switching element 24a and the second switching element 24b: switches from the first mode to the second mode upon user actuation of the digital controller; and switches from the second mode to the first mode after a predetermined time period, such as 30 seconds. Returning to a low(er) flow rate after a predetermined time period may improve water economy by offering a high(er) flow spray mode to the user only for a limited period of time specific to a required purpose, e.g. hair rinsing.

Alternately, the controller may comprise a non-digital, manually actuated valve, e.g. provided with a lever, a button or a rotatable dial for actuating the controller.

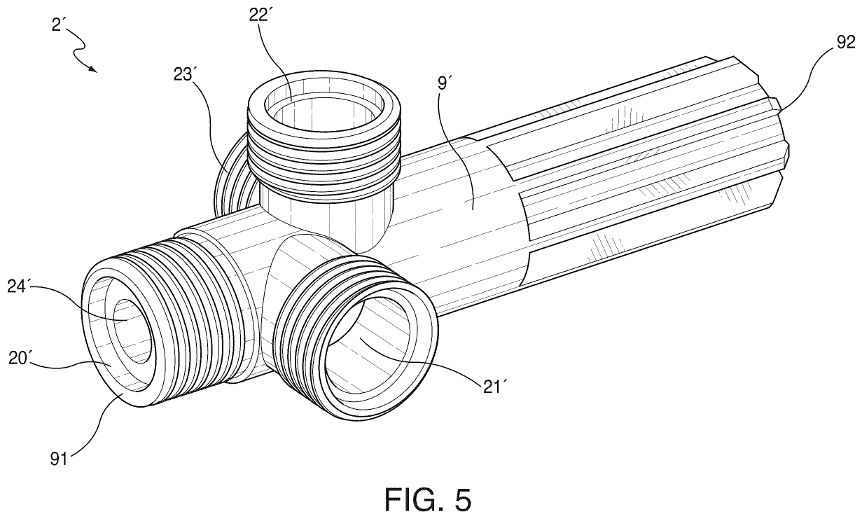

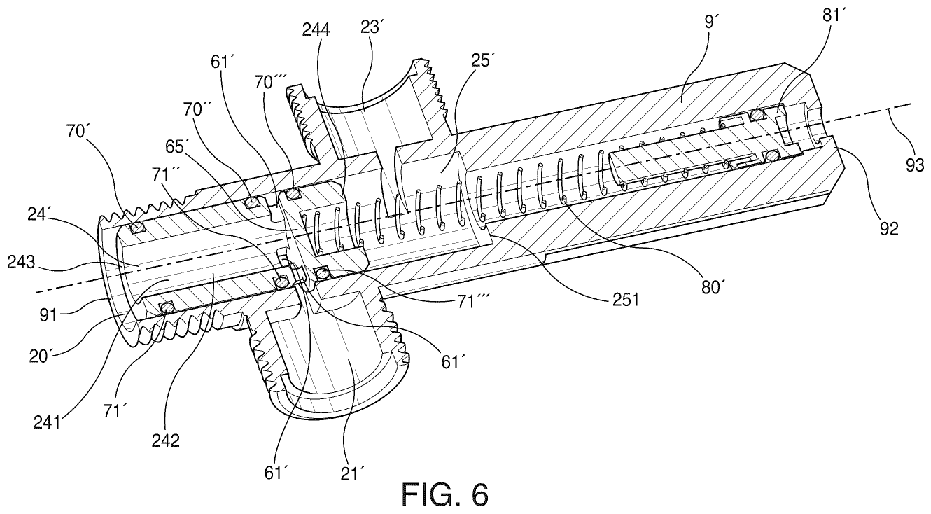

FIG. 5 shows a valve assembly 2′ for use in an ablutionary or plumbing apparatus. FIG. 6 shows a cross-sectional view of the valve assembly 2′.

The valve assembly 2′ includes an elongate body 9′. A first end 91 of the elongate body 9′ is open and includes a valve inlet 20′ for receiving, in use, fluid from a fluid supply. An elongate chamber 25′ extends from the valve inlet 20′ in a lengthwise direction within the elongate body 9′.

The elongate body 9′ includes a first valve outlet 21′. The first valve outlet 21′ communicates with the elongate chamber 25′. The first valve outlet 21′ extends away from a longitudinal axis 93 of the elongate body 9′ in a direction perpendicular to the longitudinal axis 93 of the elongate body 9′.

The elongate body 9′ includes a second valve outlet 22′. The second valve outlet 22′ communicates with the elongate chamber 25′ at a position further from the first end 91 of the elongate body 9′ than the position at which the first valve outlet 21′ communicates with the elongate chamber 25′. The second valve outlet 22′ extends away from the longitudinal axis 93 of the elongate body 9′ in a direction perpendicular to the longitudinal axis 93 of the elongate body 9′. The direction in which the second valve outlet 22′ extends away from the longitudinal axis 93 of the elongate body 9′ is perpendicular to the direction in which the first valve outlet 21′ extends away from the longitudinal axis 93 of the elongate body 9′.

The elongate body 9′ includes a third valve outlet 23′. The third valve outlet 23′ communicates with the elongate chamber 25′ at a position further from the first end 91 of the elongate body 9′ than the position at which the second valve outlet 22′ communicates with the elongate chamber 25′. The third valve outlet 23′ extends away from the longitudinal axis 93 of the elongate body 9′ in a direction perpendicular to the longitudinal axis 93 of the elongate body 9′. The direction in which the third valve outlet 23′ extends away from the longitudinal axis 93 of the elongate body 9′ is perpendicular to the direction in which the second valve outlet 22′ extends away from the longitudinal axis 93 of the elongate body 9′ and is opposite to the direction in which the first valve outlet 21′ extends away from the longitudinal axis 93 of the elongate body 9′.

A switching device 24′ comprises a carriage 241 received within the elongate chamber 25′. The carriage 241 is movable longitudinally within the elongate chamber 25′. The carriage 241 is tubular in form with a plate 65′ blocking fluid communication along a central passage 242 from a first end 243 to a second end 244 of the carriage 241.

At a position along the length of the carriage 241 between the first end 243 and the plate 65′, there are four apertures 61′ spaced equally around a circumference of the carriage 241. The apertures 61′ are arranged so that one of them can be brought into alignment with one of the first valve outlet 21′, the second valve outlet 22′ and the third valve outlet 23′ depending upon the longitudinal position of the carriage 241 within the elongate chamber 25′.

A first o-ring seal 70′ is received in a first annular groove 71′ extending around an outer surface of the carriage 241. The first annular groove 71′ is located close to the first end 243 of the carriage 241. The first o-ring seal 70′ provides a fluid-tight seal between the outer surface of the carriage 241 and an inner surface of the elongate body 9′.

A second o-ring seal 70″ is received in a second annular groove 71″ extending around the outer surface of the carriage 241. The second annular groove 71″ is located close to the four apertures 61″ spaced equally around the circumference of the carriage 241. The second o-ring seal 70″ provides a fluid-tight seal between the outer surface of the carriage 241 and the inner surface of the elongate body 9′.

A third o-ring seal 70′″ is received in a third annular groove 71′″ extending around the outer surface of the carriage 241. The third annular groove 71′″ is located close to the four apertures 61′ on the opposite side of the four apertures 61′ from the second annular groove 71″. The third o-ring seal 70′″ provides a fluid-tight seal between the outer surface of the carriage 241 and the inner surface of the elongate body 9′.

A spring 80′ is connected at a first end to the plate 65′ and at a second end to an insert 81′ fixed within the elongate chamber 25′ at a location close to a second end 92 of the elongate body 9′. The spring 80′ is configured to bias the carriage 241 towards a position (as shown in FIG. 6) where one of the apertures 61′ is aligned with the first valve outlet 21′.

An inner surface of the elongate chamber 25′ comprises a step 251. The step 251 connects a wider portion of the elongate chamber 25′ to a narrower portion of the elongate chamber 25′. The carriage 241 is disposed within the wider portion of the elongate chamber 25′. The insert 81′ is located within the narrower portion of the elongate chamber 25′.

The valve inlet 20′, the first valve outlet 21′, the second valve outlet 22′ and the third valve outlet 23′ all have an outer threaded portion to facilitate connection to other sections of tubing.

In FIG. 6, the switching element 24′ is shown in a first mode. In the first mode, one of the apertures 61′ is aligned with the first valve outlet 21′. In the first mode, fluid flows, in use, from the valve inlet 20′ into the central passage 242 of the carriage 241 and through one of the apertures 61′ into the first valve outlet 21′. In the first mode, the carriage 241 is positioned to enable fluidic connection between the valve inlet 20′ and the first valve outlet 21′, while preventing fluidic connection between the valve inlet 20′ and both of the second valve outlet 22′ and the third valve outlet 23′.

The spring 80′ acts to resist movement of the carriage 241 from its position in the first mode. In this way, the valve assembly 2′ is configured such that flow from the valve inlet 20′ establishes a reaction force within the spring 80′, which acts to oppose movement of the carriage 241.

When the fluidic pressure acting on the switching element 24′ meets or exceeds a first threshold fluidic pressure, the force of the fluidic pressure on the plate 65′ exceeds a first reaction force of the spring 80′. Due to this imbalance of forces, the carriage 241 translates along the length of the elongate chamber 25′ until another one of the apertures 61′ is aligned with the second valve outlet 22′ at which point the switching element 24′ is said to be operating in a second mode.

In the second mode, the carriage 241 is positioned so as to enable fluidic connection between the valve inlet 20′ and the second valve outlet 22′ while preventing fluidic connection between the valve inlet 20′ and each of the first valve outlet 21′ and the third valve outlet 23′.

When the fluidic pressure acting on the switching element 24′ meets or exceeds a second threshold fluidic pressure (higher than the first threshold fluidic pressure), the force of the fluidic pressure on the plate 65′ exceeds a second reaction force of the spring 80′. Due to this imbalance of forces, the carriage 241 translates along the length of the elongate chamber 25′ until another one of the apertures 61′ is aligned with the third valve outlet 23′ at which point the switching element 24′ is said to be operating in a third mode.

In the third mode, the carriage 241 is positioned so as to enable fluidic connection between the valve inlet 20′ and the third valve outlet 23′ while preventing fluidic connection between the valve inlet 20′ and both of the first valve outlet 21′ and the second valve outlet 22′. The second end 244 of the carriage 241 abuts the step 251 when the switching element 24′ is in the third mode. The step 251 therefore prevents the carriage 241 from moving to a position beyond the third mode.

In this way, the switching element 24′ is actuated by fluidic pressure and configured to switch from operating in the first mode to operating in the second mode or the third mode (and vice versa), as a result of a change in fluidic pressure. Such pressure-induced switching may provide a compact alternative to costly and complex digitally controlled switching methods.

The valve assembly 2′ may further comprise one or more check valves and/or pressure relief valves each arranged within an opening from the elongate chamber 25′ to one of the first, second and third valve outlets 21′, 22′, 23′. Each of the check valves and/or pressure relief valves may be configured to prevent back flow from one of the first, second and third valve outlets 21′, 22′, 23 into the chamber elongate chamber 25′. Each check valve and/or pressure relief valve may also prevent leaking from one of the valve outlets 21′, 22′.

The valve assembly 2′ may include a first flow regulator (not shown) located downstream of a first outlet from the elongate chamber 25′ and upstream of the first valve outlet 21′. The first flow regulator may be configured to limit a maximum flow rate output from the first valve outlet 21′. The first flow regulator may comprise a flow regulating geometry within the valve assembly 2′, e.g. a restricting plate with one or more orifices therethrough.

The valve assembly 2′ may include a second flow regulator (not shown) located downstream of a second outlet from the elongate chamber 25′ and upstream of the second valve outlet 22′. The second flow regulator may be configured to limit a maximum flow rate output from the second valve outlet 22′. The second flow regulator may comprise a flow regulating geometry within the valve assembly 2′, e.g. a restricting plate with one or more orifices therethrough.

In implementations, the valve assembly may comprise any number of valve outlets.

In implementations, there may be one fewer flow regulators than valve outlets.

The or each flow regulator may be configured to limit a maximum flow rate output from a given valve outlet downstream thereof. The or each flow regulator may comprise a flow regulating geometry within the valve assembly, e.g. a restricting plate with one or more orifices therethrough.

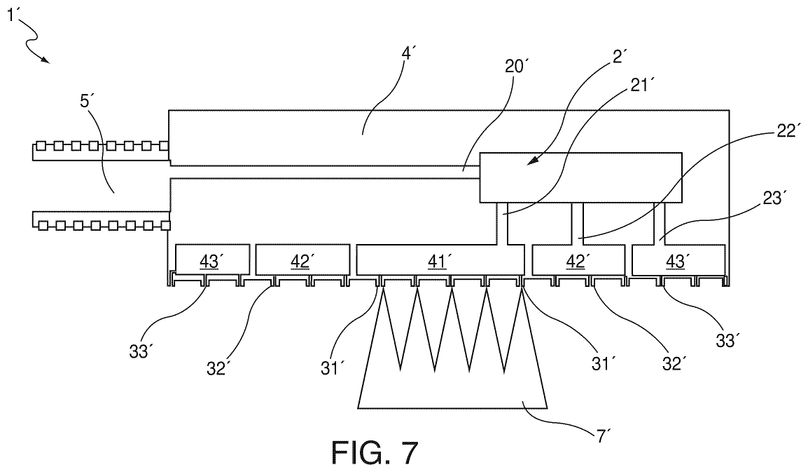

FIGS. 7, 8 and 9 show another example of an ablutionary apparatus 1′. The ablutionary apparatus 1′ comprises the valve assembly 2′ of FIGS. 5-6. In this example, the apparatus 1′ comprises a spray head 4′ for a shower. As shown in FIG. 7, the spray head 4′ comprises an apparatus inlet 5′ which is threaded to enable coupling to a fluid supply pipe (not shown). The valve assembly 2′ is arranged to fluidically couple to the fluid supply pipe via the apparatus inlet 5′.

The spray head 4′ comprises a spray face 3′ which includes a first set of fluid delivery outlets 31′, a second set of fluid delivery outlets 32′ and a third set of fluid delivery outlets 33′. The first set of fluid delivery outlets 31′ is located in a centre of the spray face 3′ while the third set of fluid delivery outlets 33′ is disposed around a perimeter of the spray face 3′. The second set of fluid delivery outlets 32′ is disposed on the spray face between the first set of fluid delivery outlets 31′ and the third set of fluid delivery outlets 33′ such that the first set of fluid delivery outlets 31′ is encircled by the second set of fluid delivery outlets 32′ and both the first set of fluid delivery outlets 31′ and the second set of fluid delivery outlets 32′ are encircled by the third set of fluid delivery outlets 33′.

The spray head 4′ further comprises: a first chamber 41′ configured to supply fluid to the first set of fluid delivery outlets 31′; a second chamber 42′ configured to supply fluid to a second set of fluid delivery outlets 32′; and a third chamber 43′ configured to supply fluid to a third set of fluid delivery outlets 33′. In this example, the second chamber 42′ and the third chamber 43′ are substantially annular in shape. The second chamber 42′ is arranged to encircle the first chamber 41′ while the third chamber 43′ is arranged to encircle the first chamber 41′ and the second chamber 42′.

The apparatus 1′ is configured such that the first valve outlet 21′ of the valve assembly 2′ is in fluid communication with the first set of fluid delivery outlets 31′ via the first chamber 41′. The apparatus 1′ is configured such that: the second valve outlet 22′ is in fluid communication with the second set of fluid delivery outlets 32′ via the second chamber 42′; and the third valve outlet 23′ is in fluid communication with the third set of fluid delivery outlets 33′ via the third chamber 43′.

In FIG. 7, the spray head 4′ is shown with the switching element 24′ of the valve assembly 2′ operating in its first mode. In this mode, the valve inlet 20′ is fluidically connected to the first valve outlet 21′ and is not fluidically connected to either of the second valve outlet 22′ or the third valve outlet 23′. As such, fluid is only supplied to the first set of fluid delivery outlets 31′ and the spray head 4′ is said to operate in a first spray mode. Fluid being delivered by the first set of fluid delivery outlets 31′ is represented by grey triangles 7′.

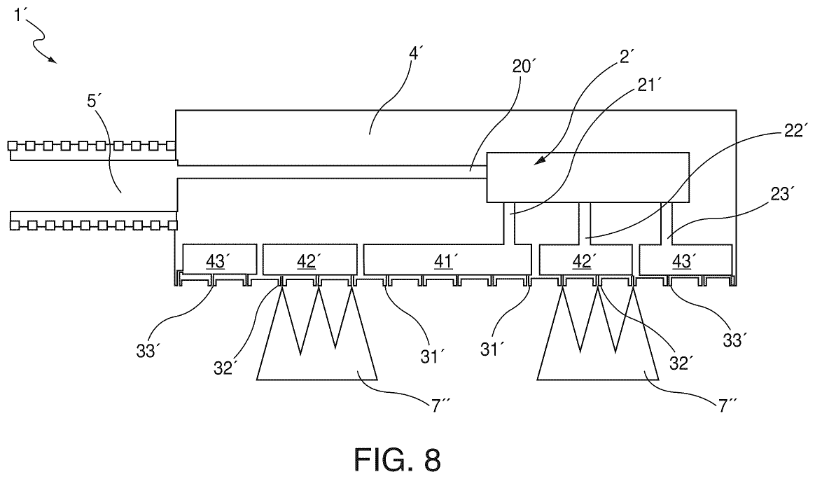

FIG. 8 shows the ablutionary apparatus 1′ operating when the fluidic pressure acting on the switching element 24′ is above the first threshold fluidic pressure but below the second threshold fluidic pressure. At this fluid pressure, the switching element 24′ is in its second mode wherein the carriage 241 (FIG. 6) is positioned such that one of the apertures 61′ (FIG. 6) aligns with the second valve outlet 22′, thereby enabling fluidic connection between the valve inlet 20′ and the second set of fluid delivery outlets 32′, while preventing fluidic connection between the valve inlet 20′ and each of the first and third valve outlets 21′, 23′. As such, fluid is only supplied to the second set of fluid delivery outlets 32′ and the spray head 4′ is said to operate in a second spray mode. Fluid being delivered by the second set of fluid delivery outlets 32′ is represented by grey triangles 7″.

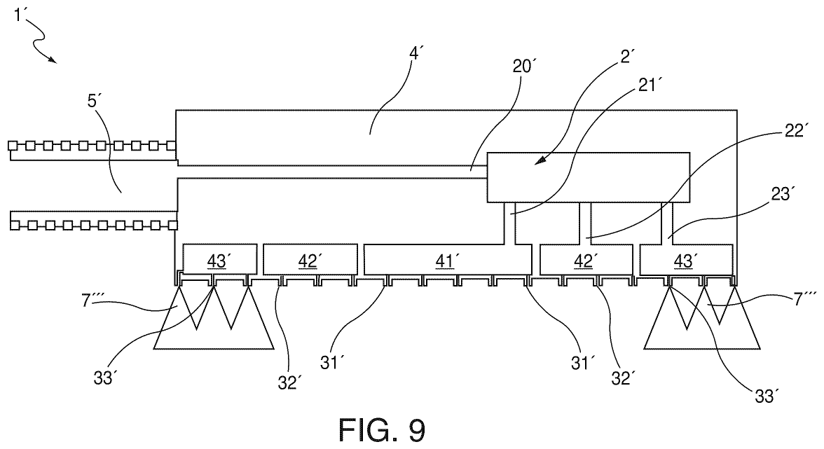

FIG. 9 shows the ablutionary apparatus 1′ operating when the fluidic pressure acting on the switching element 24′ is above the second threshold fluidic pressure. At this fluidic pressure, the switching element 24′ is in its third mode wherein the carriage 241 (FIG. 6) is positioned such that one of the apertures 61′ (FIG. 6) aligns with the third valve outlet 23′, thereby enabling fluidic connection between the valve inlet 20′ and the third set of fluid delivery outlets 33′, while preventing fluidic connection between the valve inlet 20′ and each of the first and second valve outlets 21′, 22′. As such, fluid is only supplied to the third set of fluid delivery outlets 33′ and the spray head 4′ is said to operate in a third spray mode. Fluid being delivered by the third set of fluid delivery outlets 33′ is represented by grey triangles 7′″.

In this way, the switching element 24′ is actuated by fluidic pressure and configured to switch from operating in the first mode to operating in the second mode to operating in the third mode, and vice versa, as a result of a change in fluidic pressure. As such, the valve assembly 2′ may act as a diverter valve assembly, wherein switching between the first, second and third valve outlets 21′, 22′, 23′ may be actuated by both increasing and decreasing fluidic pressure (through a threshold fluid pressure). This may provide an advantage over conventional diverter valve assemblies, which may maintain a selected outlet using fluid pressure but are not operable to switch outlets should the pressure increase. Such conventional diverter valve assemblies typically require direct manual or digital actuation of the valve itself. In contrast, the reversible pressure induced spray mode switching described in this disclosure may provide a compact alternative to conventional switching methods which often require direct user actuation of the valve(s).

While the exemplar valve assembly 2′ shown in FIGS. 5-6, is described as having only three spray modes, a person skilled in the art will appreciate that the principles described herein can be scaled to include any number of valve outlets and respective spray modes.

The ablutionary apparatus 1′ may comprise a controller (not shown) for varying the flow rate from the fluid supply to the at least one valve inlet 20′. Varying the flow rate from the fluid supply may be used to vary the fluidic pressure acting on the switching element 24′, to switch the switching element 24′ between modes. Such a controller may be a digital controller configured to vary the flow rate from the fluid supply such that the switching element: switches from the first mode to the second mode upon user actuation of the digital controller; and switches from the second mode to the first mode after a predetermined time period, such as 30 seconds. Returning to a low flow rate after a predetermined time period may improve water economy by offering a high(er) flow spray mode to the user only for a limited period of time specific to a required purpose, e.g. hair rinsing.

Alternately, the controller may comprise a non-digital, manually actuated valve, e.g., provided with a lever, a rotatable dial or a button for actuating the controller.

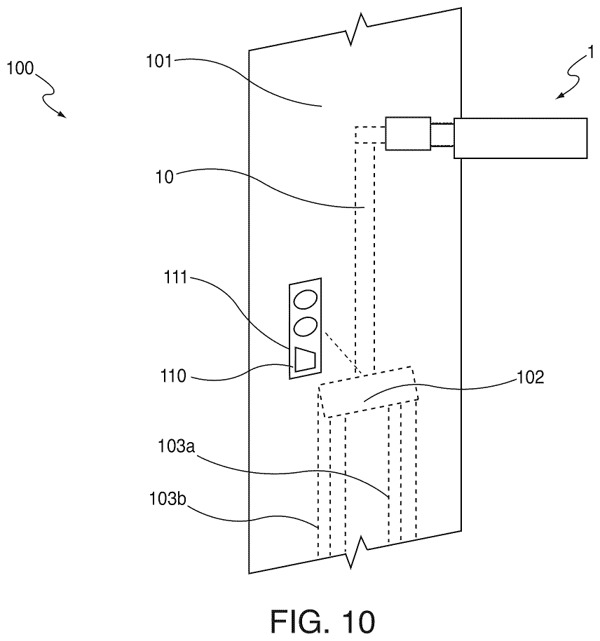

FIG. 10 shows a system 100 installed in an ablutionary environment. The system 100 comprises the apparatus 1 shown in FIGS. 2 and 3. Part of the system 100 may be disposed behind a panel 101 of the ablutionary environment (e.g., a shower panel wall). Features that may be positioned behind the panel 101 are shown in FIG. 10 using dashed lines.

The system 100 comprises a controller 110 for varying the flow rate from the fluid supply to the apparatus 1. The system 100 further comprises a mixing valve 102 operable to control the relative supply provided to a fluid supply pipe 10 by each of a hot fluid supply pipe 103a and cold fluid supply pipe 103b (fluidically connected to a hot and a cold fluid source respectively). The controller 110 comprises a digital controller 111 electrically connected to and operable to control the mixing valve 102. In this way, actuation of the digital controller 111 operates to vary a flow rate within the fluid supply pipe 10. The valve inlet 20 (FIG. 2, FIG. 3) is configured to receive, in use, fluid from the fluid supply pipe 10.

Varying the flow rate from the fluid supply may be used to vary the fluidic pressure acting on the switching element 24 (FIG. 2, FIG. 3), to actuate switching between spray modes of the apparatus 1.

The digital controller 111 may be configured to vary the flow rate from the fluid supply such that the switching element 24 (FIG. 2, FIG. 3): switches from the first mode to the second mode upon user actuation of the digital controller 111; and switches from the second mode to the first mode after a predetermined time period, such as 30 seconds.

Returning to a low(er) flow rate after a predetermined time period may improve water economy by offering a high(er) flow spray mode to the user only for a limited period of time specific to a required purpose, e.g. hair rinsing.

Alternatively, the controller may comprise a manual (non-digital) controller (e.g., including a button, rotatable dial or lever) configured to be manually actuated by a user to control the mixing valve 102 and by extension actuate the switching element 24 (FIG. 2, FIG. 3) to switch between spray modes of the apparatus 1.

In the example shown in FIG. 10, the system 100 is described as comprising apparatus 1 shown in FIGS. 2-3. However, a person skilled in the art will understand that the apparatus 1 may be substituted such that the system 100 may comprise any apparatus according to the present disclosure, e.g., the apparatus 1a shown in FIG. 4 or the apparatus 1′ shown in FIGS. 7-9.

Conventional shower systems typically may comprise a means for manually controlling the fluidic pressure and/or flow rate of the showerhead. The valve assembly of the present disclosure is configured such that switching between spray modes may be actuated by such a means of controlling the fluidic pressure and/or flow rate. As such, the valve assembly may be easily retrofitted into a conventional shower system to increase functionality of the shower system without requiring installation of new controllers. This single control switching may also reduce maintenance costs and reliability of the shower system when compared with conventional spray mode switching means, which are often complex and may have many parts that may be prone to failure. For example, digitally-actuated valves within a showerhead may be prone to failure as showerheads often leak, experience submersion in fluid, and are subject to a high humidity environment. The valve assembly of the present invention does not require the showerhead to be electrically connected to a controller. For the valve assembly of the present invention, spray mode switching may be actuated via a remote digital or manual controller (for varying flow rate and/or fluidic pressure) located upstream of the showerhead. In this way, the valve assembly may have better reliability and ease of spray mode actuation than conventional shower systems that rely on digital valve control (within a showerhead) or manual actuation of the showerhead itself for spray mode switching.

The examples shown in FIGS. 1-9 show specific valve outlet positions and configurations of the chambers and respective sets of fluid delivery outlets. However, it will be appreciated by the person skilled in the art that conduits may be used to deliver flow from outlets to chambers and from chambers to each set of fluid delivery outlets such that the configuration of the valve outlets, chambers and sets of fluid delivery outlets may be varied independently of one another while maintaining functionality. As such, the spray coverage associated with each spray mode may be tailored to suit a specific application. For example, the third set of fluid delivery nozzles may be positioned within a centre/core of the spray face and have a smaller footprint on the spray face than either of the first or second set of fluid delivery outlets. The higher net flow rate associated with the third spray mode and the smaller spray face coverage of the third set of fluid delivery outlets may be used to produce a high velocity flow which may have utility in certain washing applications e.g., hair washing. A person skilled in the art will understand that other configurations of the fluid delivery outlets and the chambers are possible without departing from the scope of this disclosure.

It is an object of the present invention to at least partially ameliorate the issues of conventional multi-mode spray heads described in the preceding paragraphs.

A first aspect provides an ablutionary or plumbing apparatus comprising: a valve assembly comprising: at least one valve inlet configured to be connected to a fluid supply pipe; two or more valve outlets including a first valve outlet and a second valve outlet; a switching element operable to selectively allow fluid communication between the at least one inlet and the first valve outlet and/or the second valve outlet, wherein: when the fluidic pressure acting on the switching element is below a threshold fluidic pressure, the switching element operates in a first mode to allow fluid communication between the at least one inlet and the first valve outlet and prevents fluid communication between the at least one inlet and the second valve outlet; when the fluidic pressure acting on the switching element meets or exceeds the threshold fluidic pressure, the switching element operates in a second mode to allow fluid communication between the at least one inlet and the second valve outlet; and the switching element is actuated by fluidic pressure and configured to switch from operating in the first mode to operating in the second mode and vice versa, as a result of a change in fluidic pressure through the threshold fluidic pressure; a first set of fluid delivery outlets for providing a first spray mode, the first set of fluid delivery outlets being in fluid communication with the first valve outlet; and a second set of fluid delivery outlets for providing a second spray mode, the second set of fluid delivery outlets being in fluid communication with the second valve outlet.

The fluid supply pipe may form part of the apparatus.

The valve assembly may be configured such that when the switching element operates in a second mode, the valve assembly allows fluid communication between the at least one valve inlet and the first valve outlet.

The valve assembly may comprise at least one pressure relief valve. One or more of the pressure relief valves may be disposed within one of the valve outlets, e.g. the first valve outlet or the second valve outlet.

The valve assembly may further include an antechamber which connects the at least one valve inlet to the first valve outlet. The antechamber may selectively connect the at least one valve inlet to the second valve outlet, e.g. via the pressure relief valve.

At least one of the two or more valve outlets may comprise a flow regulator configured to limit a maximum flow rate output from said valve outlet.

Each of the valve outlets may comprise a flow regulator configured to limit a maximum flow rate output from said valve outlet.

The first valve outlet may comprise a flow regulator. The second valve outlet may not comprise a flow regulator.

The or each or flow regulator may comprise a stop check valve and/or a pressure relief valve.

The valve assembly may be configured such that when flow from the first valve outlet reaches the maximum flow rate output limit, the fluidic pressure acting on the switching element meets or exceeds the threshold fluidic pressure to open the pressure relief valve and the switching element switches to the second mode.

The valve assembly may include an elongate chamber which selectively connects the at least one inlet to the first valve outlet. The elongate chamber may selectively connect the at least one inlet to the second valve outlet.

The valve assembly may be configured such that when the switching element operates in a second mode, the valve assembly prevents fluid communication between the at least one inlet and the first valve outlet.

The valve assembly may be a diverter valve assembly.

The switching element may comprise, or consist essentially of, a moveable carriage configured to translate relative to the two or more valve outlets.

The moveable carriage may be perforated with one or more apertures. Each aperture may enable fluidic connection between the at least one valve inlet and one of the two or more valve outlets.

The switching element may further comprise a resilient means such as a spring. The valve assembly may be configured such that flow from the at least one inlet establishes a reaction force of the resilient means which acts on the carriage.

The valve assembly may be configured such that when the fluidic pressure acting on the switching element overcomes the reaction force, the switching element switches from the first mode to the second mode.

The two or more valve outlets may comprise one or more additional valve outlets each associated with a respective additional mode of the switching element and an additional spray mode of the apparatus. For example, the two or more valve outlets may comprise or consist of three, four, five or more than five valve outlets.

The movable carriage may be perforated with two or more apertures. The apertures may be distributed around a circumference of the carriage.

The apertures may comprise a first set of apertures and a second set of apertures offset from the first set of apertures along a length of the moveable carriage. The offset between the first set of apertures and the second set of apertures along the length of the moveable carriage may be substantially equal to an offset between two of the valve outlets along the length of the or an elongate chamber (e.g., between the first valve outlet and the second valve outlet).

When the switching element is in the first mode, at least one of the first set of apertures may align with the first outlet, enabling fluidic connection between the valve inlet and the first valve outlet.

When the switching element is in the second mode: at least one of the first set of apertures may align with the second valve outlet, enabling fluidic communication between the valve inlet and the second valve outlet; and at least one of the second set of apertures may align with the first valve outlet, enabling fluidic communication between the valve inlet and the first valve outlet.

In an alternate configuration, the apertures may comprise a single set of apertures. The single set of apertures may include slots aligned with their long axes substantially parallel to the length of the moveable carriage. Each of the slots may have a length (measured along its long axis) of greater than or equal to the offset between two of the valve outlets along the length of the elongate chamber (e.g., between the first valve outlet and the second valve outlet).

When the switching element is in the first mode, at least one of the slots may at least partially align with the first outlet, enabling fluidic communication between the valve inlet and the first valve outlet. When the switching element is operating in the first mode, the valve assembly may be configured such that none of the slots overlap the second outlet such that the second valve outlet is not in fluidic communication with the valve inlet.

When the switching element is in the second mode: at least one of the slots may, at least partially, align with the second valve outlet, enabling fluidic connection between the valve inlet and the second valve outlet; and the at least one of the slots may, at least partially, align with the first valve outlet, enabling fluidic connection between the valve inlet and the first valve outlet.

The apparatus may further comprise a controller for varying flow rate from a fluid supply pipe to the at least one valve inlet.

The apparatus may be configured such that actuating the controller varies the fluidic pressure acting on the switching element, thereby switching the switching element between modes of operation.

Varying the flow rate from the fluid supply may be used to vary the fluidic pressure acting on the switching element to switch the switching element between modes.

The controller may be configured to vary the flow rate from the fluid supply such that the switching element: switches from the first mode to the second mode or the or a third mode upon user actuation of the controller; and switches from the second mode to the first mode after a predetermined time period, such as 30 seconds. Returning to a low flow rate after a predetermined time period may improve water economy by offering a high(er) flow spray mode to the user only for a limited period of time specific to a required purpose, e.g. hair rinsing.

The controller may be a digital controller.

The digital controller may be configured such that the switching element: switches from the first mode to another mode of operation upon user actuation of the digital controller; and/or switches to the first mode after a predetermined time period.

The predetermined time period may be greater than or equal to 10 seconds, greater than or equal to 20 seconds, greater than or equal to 30 seconds, greater than or equal to 40 seconds or greater than or equal to 1 minute.

The predetermined time period may be less than 20 seconds, less than 30 seconds, less than 40 seconds, less than 1 minute or less than 5 minutes.

The controller, e.g. the or a digital controller, may be configured such that the switching element: switches from the first mode to another mode of operation upon user actuation of the digital controller; and/or switches to the first mode once a limiting condition is met.

The limiting condition may be a or the predetermined time period having elapsed or a predetermined volume of fluid having been output from the or a selection of the fluid delivery outlets (e.g., from the first set of fluid delivery outlets and/or the second set of fluid delivery outlets).

The ‘another mode of operation’ may be the second mode.

The predetermined time period and/or the predetermined volume of fluid may be measured from when the switching element was last operating in the first mode.

The predetermined time period and/or the predetermined volume of fluid may be measured from when the switching element most recently switched modes.

The predetermined volume of fluid may be greater than or equal to 2 litres, greater than or equal to 3 litres, greater than or equal to 4 litres or greater than or equal to 5 litres.

The predetermined volume of fluid may be less than 2 litres, less than 3 litres, less than 4 litres or less than 5 litres.

The controller may comprise, or consist essentially of, a non-digital manually actuated valve.

The controller may be provided with a lever, a button or a rotatable dial for actuating the controller.

The apparatus may not require digital or manual actuation by a user to switch between modes.

The apparatus may comprise a spray head for a shower. The spray head may be a handheld spray head or a fixed shower fitting, e.g. an overhead shower or a shower fitting fixed to a wall.

Any one or more of the valve assembly, the first set of fluid delivery outlets, the second set of fluid delivery outlets, and/or the controller may form part of the spray head.

The valve assembly and/or the controller may be enclosed at least partially, e.g. enclosed entirely, within the spray head.

The controller may be remote from the spray head.

The controller may not be electronically connected to the spray head (wired or wirelessly) to enable switching between modes.

The controller may be upstream of the at least one valve inlet.

A second aspect provides a system for installation in an ablutionary environment, comprising: an apparatus according to the first aspect; and a controller for varying the flow rate from the fluid supply to the apparatus.

The system may further comprise a mixing valve. The mixing valve may be operable to control the relative supply provided to the fluid supply pipe by each of two system fluid supply pipes. The two system fluid supply pipes may form part of the system and may include a hot fluid supply pipe which is fluidically connected to a hot fluid source and a cold fluid supply pipe which is fluidically connected to a cold fluid source.

The system may be configured such that actuating the controller varies the fluidic pressure acting on the switching element, thereby switching the switching element between modes of operation.

Varying the flow rate from the fluid supply may be used to vary the fluidic pressure acting on the switching element to switch the switching element between modes.

The controller may be configured to vary the flow rate from the fluid supply such that the switching element: switches from the first mode to the second mode or the or a third mode upon user actuation of the controller; and switches from the second mode to the first mode after a predetermined time period, such as 30 seconds.

Returning to a low(er) flow rate after a predetermined time period may improve water economy by offering a high(er) flow spray mode to the user only for a limited period of time specific to the required purpose e.g. hair rinsing.

The controller may be a digital controller.

The digital controller may be electrically connected to and operable to control the mixing valve. The digital controller may be electrically connected to the mixing valve by a wired or wireless connection.

The digital controller may be operable to vary a flow rate within the fluid supply pipe.

The digital controller may be configured such that the switching element: switches from the first mode to another mode of operation upon user actuation of the digital controller; and/or switches to the first mode after a predetermined time period.

The predetermined time period may be greater than or equal to 10 seconds, greater than or equal to 20 seconds, greater than or equal to 30 seconds, greater than or equal to 40 seconds or greater than or equal to 1 minute.

The predetermined time period may be less than 20 seconds, less than 30 seconds, less than 40 seconds, less than 1 minute or less than 5 minutes.

The controller, e.g. the or a digital controller, may be configured such that the switching element: switches from the first mode to another mode of operation upon user actuation of the digital controller; and/or switches to the first mode once a limiting condition is met.

The limiting condition may be a or the predetermined time period having elapsed or a predetermined volume of fluid having been output from the or a selection of the fluid delivery outlets (e.g., from the first set of fluid delivery outlets and/or the second set of fluid delivery outlets).

‘Another mode of operation’ may be the second mode.

The predetermined time period and/or the predetermined volume of fluid may be measured from when the switching element was last operating in the first mode.

The predetermined time period and/or the predetermined volume of fluid may be measured from when the switching element most recently switched modes.

The predetermined volume of fluid may be greater than or equal to 2 litres, greater than or equal to 3 litres, greater than or equal to 4 litres or greater than or equal to 5 litres.

The predetermined volume of fluid may be less than 2 litres, less than 3 litres, less than 4 litres or less than 5 litres.

The controller may comprise or consist essentially of a non-digital manually actuated valve.

The controller may be provided with a lever, a button or a rotatable dial for actuating the controller. The apparatus may not require digital or manual actuation by a user to switch between modes.

The apparatus may comprise a spray head for a shower. The spray head may be a handheld spray head or a fixed shower fitting, e.g. an overhead shower or a shower fitting fixed to a wall.

Any one or more of the valve assembly, the first set of fluid delivery outlets, the second set of fluid delivery outlets, and/or the controller may form part of the spray head.

The valve assembly and/or the controller may be enclosed at least partially within, e.g. enclosed entirely within, the spray head.

The controller may be remote from the spray head.

The controller may not be electronically connected to the spray head (wired or wirelessly) to enable switching between modes.

The controller may be upstream of the at least one valve inlet.

This disclosure is intended to be read such that any separable features or elements of the disclosed invention, in any of its various aspects and embodiments, should be viewed as intended to be combinable unless the context clearly dictates otherwise. For example, the controller described in relation to the first aspect of the disclosure may be the implemented as the controller of the system according to the second aspect of the disclosure or vice versa. Any features of the controller described in relation to the first aspect of the disclosure may be attributed to the controller of the system according to the second aspect of the disclosure and/or vice versa. Further, where considered appropriate, reference labels have been repeated among the figures to indicate corresponding or analogous elements.

It will be understood that the invention is not limited to the embodiments above-described and various modifications and improvements can be made without departing from the concepts herein. Except where mutually exclusive, any of the features may be employed separately or in combination with any other features and the disclosure extends to and includes all combinations and sub-combinations of one or more features described herein.

1. An apparatus comprising:
a valve assembly including:
at least one valve inlet adapted to connect to a fluid supply pipe;
two or more valve outlets including a first valve outlet and a second valve outlet;
a switching element selectively allowing fluid communication between the at least one inlet and the first valve outlet and/or the second valve outlet, wherein:
when fluidic pressure acting on the switching element is below a threshold fluidic pressure, the switching element operates in a first mode in which the at least one inlet and the first valve outlet are in fluid communication, and the at least one inlet and the second valve outlet are not in fluid communication;
when the fluidic pressure acting on the switching element meets or exceeds the threshold fluidic pressure, the switching element operates in a second mode in which the at least one inlet and the second valve outlet are in fluid communication; and
the switching element is actuated by fluidic pressure and switches from operating in the first mode to operating in the second mode and vice versa, as a result of a change in fluidic pressure through the threshold fluidic pressure;
a first set of fluid delivery outlets for providing a first spray mode, the first set of fluid delivery outlets being in fluid communication with the first valve outlet; and
a second set of fluid delivery outlets for providing a second spray mode, the second set of fluid delivery outlets being in fluid communication with the second valve outlet.

2. The apparatus of claim 1, wherein when the switching element operates in the second mode, the valve assembly allows fluid communication between the at least one valve inlet and the first valve outlet.

3. The apparatus of claim 1, wherein the valve assembly includes at least one pressure relief valve.

4. The apparatus of claim 1, wherein at least one of the two or more valve outlets includes a flow regulator configured to limit a maximum flow rate output from said valve outlet.

5. The apparatus of claim 1, wherein when the switching element operates in the second mode, the valve assembly prevents fluid communication between the at least one inlet and the first valve outlet.

6. The apparatus of claim 1, wherein the valve assembly includes a diverter valve assembly.

7. The apparatus of claim 1, wherein the switching element includes a moveable carriage that translates relative to the two or more valve outlets.

8. The apparatus of claim 7, wherein the moveable carriage is perforated with one or more apertures to enable fluidic connection, in use, between the at least one valve inlet and one of the two or more valve outlets.

9. The apparatus of claim 7, wherein the switching element further includes a resilient means.

10. The apparatus of claim 7, wherein the moveable carriage is perforated with two or more apertures and wherein the apertures are distributed around a circumference of the carriage.

11. The apparatus of claim 7, wherein the apertures include a first set of apertures and a second set of apertures offset from the first set of apertures along a length of the moveable carriage.

12. The apparatus of claim 7, wherein the apertures include a single set of apertures.

13. The apparatus of claim 1, further including a controller for varying flow rate from a fluid supply pipe to the at least one valve inlet.

14. A system for installation in an ablutionary environment, comprising:
a valve assembly including:
at least one valve inlet;
two or more valve outlets including a first valve outlet and a second valve outlet;
a switching element, wherein:
when in a first mode in which fluidic pressure acting on the switching element is below a threshold fluidic pressure, the at least one inlet and the first valve outlet are in fluid communication, and the at least one inlet and the second valve outlet are not in fluid communication;
when in a second mode in which the fluidic pressure acting on the switching element meets or exceeds the threshold fluidic pressure, the at least one inlet and the second valve outlet are in fluid communication; and
the switching element switches from operating in the first mode to operating in the second mode and vice versa based on fluidic pressure;
a first set of fluid delivery outlets for providing a first spray mode, the first set of fluid delivery outlets being in fluid communication with the first valve outlet;
a second set of fluid delivery outlets for providing a second spray mode, the second set of fluid delivery outlets being in fluid communication with the second valve outlet; and
a controller for varying the flow rate from the fluid supply to the apparatus.

15. The system of claim 14 further including a mixing valve.

16. The system of claim 14, wherein the controller varies the fluidic pressure acting on the switching element, thereby switching the switching element between modes of operation.

17. The system of claim 14, wherein the controller is a digital controller.

18. The system of claim 17, wherein the digital controller causes the switching element to:
switch from the first mode to another mode of operation upon user actuation of the digital controller; and/or
switch to the first mode after a predetermined time period.

19. The system of claim 14, wherein the controller causes the switching element to:
switch from the first mode to another mode of operation upon user actuation of the digital controller; and/or
switch to the first mode once a limiting condition is met.

20. The system of claim 19, wherein the limiting condition is that the predetermined time period has elapsed or a predetermined volume of fluid has been output from the fluid delivery outlets.
